(19) United States
(12) Patent Application Publication
(10) Pub. No.: US 2024/0039106 A1
(43) Pub. Date: Feb. 1, 2024

(54) BATTERY SYSTEM INCLUDING CYLINDRICAL BATTERY CELLS

(71) Applicant: HYUNDAI MOBIS CO., LTD., SEOUL (KR)

(72) Inventor: Sang Woo KIM, Hwaseong-si (KR)

(73) Assignee: HYUNDAI MOBIS CO., LTD., SEOUL (KR)

(21) Appl. No.: 18/222,028

(22) Filed: Jul. 14, 2023

(30) Foreign Application Priority Data
Jul. 28, 2022 (KR) 10-2022-0094055

(51) Int. Cl. H01M 50/287; H01M 50/213; H01M 50/507; H01M 10/653; H01M 50/271; H01M 50/516; H01M 10/48; H01M 10/42

(52) U.S. Cl. CPC H01M 50/287; H01M 50/213; H01M 50/507; H01M 10/653; H01M 50/271; H01M 50/516; H01M 10/486; H01M 10/4257; H01M 2010/4271

(57) ABSTRACT

Provided is a battery system including cylindrical battery cells. The system includes positive and negative bus bars each installed in a housing and electrically connected to a plurality of cylindrical battery cells, and protruding into an installation space where an electronic component is installed, and a thermally-conductive adhesive layer effectively transferring heat emitted from the plurality of cylindrical battery cells to a lower cover and the housing.

### CROSS-REFERENCE TO RELATED APPLICATIONS

This application claims priority under 35 U.S.C. § 119 to Korean Patent Application No. 10-2022-0094055, filed on Jul. 28, 2022, in the Korean Intellectual Property Office, the disclosure of which is incorporated herein by reference in its entirety.

### TECHNICAL FIELD

The following disclosure relates to a battery system including cylindrical battery cells, and more particularly, to a battery system including cylindrical battery cells that is installed in a housing, having positive and negative bus bars electrically connected to the plurality of cylindrical battery cells that protrude into an installation space where an electronic component is installed, and including a thermally-conductive adhesive layer effectively transferring heat emitted from the plurality of cylindrical battery cells to a lower cover and the housing.

### BACKGROUND

A secondary battery having high ease of application based on a product group and an electrical property such as high energy density has been commonly applied not only to a portable device but also to an electric vehicle (EV) or a hybrid vehicle (HEV) driven by an electrical driving source. This secondary battery has been spotlighted as a new energy source with eco-improved friendliness and energy efficiency not only for its primary advantage in which the secondary battery may significantly reduce use of a fossil fuel but also for the fact that no by-product occurs from use of energy.

Types of secondary batteries may include a lithium ion battery, a lithium polymer battery, a nickel cadmium battery, a nickel hydrogen battery, a nickel zinc battery, and the like, and may be roughly classified into a cylindrical battery, a prismatic battery, and a pouch-type battery based on a shape of a battery case containing an electrode assembly including a positive electrode, a separator, and a negative electrode. Among these battery types, a cylindrical battery cell, which is a cell of the cylindrical battery, may have a negative electrode disposed on one side in a length direction of the battery, and positive and negative electrodes disposed on the other side in the length direction.

An operating voltage of the battery cell, which is a cell of the secondary battery, is about 2.5 V to 4.2 V, and the plurality of battery cells may thus be used by being connected in series with each other when requiring a higher output voltage. In addition, the plurality of battery cells may be used by being connected in parallel with each other based on charge/discharge capacity required for the plurality of battery cells.

Meanwhile, a battery system may also be used to use the plurality of cylindrical battery cells connected in series or parallel with each other in a vehicle. In general, in a battery system, a housing may accommodate the plurality of cylindrical battery cells, and a plurality of electronic components electrically connected to the plurality of cylindrical battery cells may be installed in the housing.

Here, one of the positive and negative bus bars electrically connected to the plurality of cylindrical battery cells may protrude to one side of the housing where the electronic components are installed, in the length direction, and the other may protrude to the other side of the housing where no electronic component is installed the length direction. In this case, a separate wire or bus bar is required to be disposed in the housing to electrically connect the positive bus bar and the negative bus bar with the electronic component, thus increasing a manufacturing cost of the battery system.

In addition, the battery system is required to effectively dissipate heat emitted from the plurality of cylindrical battery cells accommodated therein. However, when a separate heat dissipation device is disposed in the battery system for heat dissipation, the battery system may have a larger volume and an increasing manufacturing cost.

Therefore, there is a need for developing a battery system which may effectively dissipate heat emitted from the plurality of cylindrical battery cells without a separate heat dissipation device while having both the positive bus bar and the negative bus bar protruding to one side of the battery system where the electronic component is installed.

### SUMMARY

An embodiment of the present disclosure is directed to providing a battery system including cylindrical battery cells, in which positive and negative bus bars electrically connected to a plurality of cylindrical battery cells protrude to one side of the battery system where an electronic component is installed.

Another embodiment of the present disclosure is directed to providing a battery system including cylindrical battery cells, which may effectively dissipate heat emitted from a plurality of cylindrical battery cells accommodated in the battery system without a separate heat dissipation device.

Technical tasks of the present disclosure are not limited to those mentioned above, and other tasks not mentioned here may be obviously understood by those skilled in the art from the following description.

In one general aspect, a battery system including cylindrical battery cells includes: the plurality of cylindrical battery cells; a housing including an installation space where an electronic component is installed, an accommodation space having a lower part open to accommodate the plurality of cylindrical battery cells, a positive bus bar installed in the accommodation space and having one side protruding into the installation space, a negative bus bar installed in the accommodation space and having one side protruding into the installation space, and a sealing part sealing an upper part of the accommodation space, and having a plurality of insertion grooves into which one side of each of the cylindrical battery cells in a length direction where the negative electrode is disposed is inserted; a bus bar receptor including the bus bar therein, and coupled to the lower part of the accommodation space to support one side of each of the cylindrical battery cells in the length direction where the positive or negative electrode is disposed, the bus bar electrically connecting the positive electrodes of the plurality of cylindrical battery cells with the positive bus bar, and electrically connecting the negative electrodes of the plurality of cylindrical battery cells with the negative bus bar; a first thermally-conductive adhesive layer formed by applying a thermally conductive adhesive to a lower part of the bus bar receptor; a lower cover coupled to a lower part of the housing to cover the lower part of the housing including a lower part of the first thermally-conductive adhesive layer; a second thermally-conductive adhesive layer formed by applying the thermally conductive adhesive to an upper part of the sealing part except for the insertion groove; a flexible printed circuit coupled to the housing to be disposed on an upper part of the second thermally-conductive adhesive layer; a printed wiring circuit board coupled to the housing to be disposed on the upper part of the second thermally-conductive adhesive layer; at least one electronic component installed in the installation space; and an upper cover coupled to an upper part of the housing to cover the upper part of the housing including the installation space, the flexible printed circuit, and the printed wiring circuit board.

The sealing part may have a plurality of fixing grooves to which one side of each of the plurality of cylindrical battery cells adjacent to each other in the length direction where the negative electrode is disposed is at least partially exposed, and the second thermally-conductive adhesive layer may be formed by applying the thermally conductive adhesive to the fixing groove.

The positive bus bar may have a plurality of positive bus bar holes, the negative bus bar may have a plurality of negative bus bar holes, the bus bar receptor may have a plurality of bus bar receptor holes passing through the bus bar, some of the plurality of positive bus bar holes and the plurality of bus bar receptor holes may be wire-bonded to each other to electrically connect the positive bus bar with the positive electrodes of the plurality of cylindrical battery cells, and some of the plurality of negative bus bar holes and the plurality of bus bar receptor holes may be wire-bonded to each other to electrically connect the negative bus bar with the negative electrodes of the plurality of cylindrical battery cells.

The flexible printed circuit may be electrically connected to one side of at least one cylindrical battery cell in the length direction where the negative electrode exposed to the fixing groove is disposed to measure a voltage of the cylindrical battery cell, and the flexible printed circuit and the printed wiring circuit board may be electrically connected with each other.

The flexible printed circuit and one side of the cylindrical battery cell in the length direction where the negative electrode is disposed may be electrically connected with each other by wire-bonding, and the flexible printed circuit and the printed wiring circuit board may be electrically connected with each other by wire-bonding.

A chip-shaped temperature sensor may be attached to one side of at least one cylindrical battery cell in the length direction where the negative electrode is disposed, and the flexible printed circuit may be electrically connected to the temperature sensor to measure a temperature of the cylindrical battery cell.

The flexible printed circuit may be bonded or wire-bonded to the housing by using the thermally conductive adhesive, and the printed wiring circuit board may be bonded or wire-bonded to the housing by using the thermally conductive adhesive.

The electronic component may include an electronic relay, a hall sensor, and a connection bus bar.

The electronic component may include a communication connector and a high current connector installed to communicate the installation space with the outside of the housing, and capable of electrically connecting the printed wiring circuit board with a vehicle component.

The housing may be made of thermally conductive plastic.

Details of other embodiments are included in the description and drawings of the present disclosure.

### BRIEF DESCRIPTION OF THE DRAWINGS

FIG. 1 is an exploded perspective view of a battery system including cylindrical battery cells according to an embodiment of the present disclosure.

FIG. 2 is a perspective view of a housing whose lower part faces upward.

FIG. 3 is a perspective view of the housing whose lower part faces upward and accommodating a plurality of cylindrical battery cells.

FIG. 4 is a view showing an upper part of the housing.

FIG. 5 is an enlarged view of a part A of FIG. 4.

FIG. 6 is a view showing a bus bar receptor coupled to a lower part of the housing.

FIG. 7 is an enlarged view of a part B of FIG. 6.

FIG. 8 is a view showing a flexible printed circuit board and a printed wiring circuit board coupled to the upper part of the housing.

FIG. 9 is an enlarged view of a part C of FIG. 8.

FIG. 10 is a view showing an electronic component installed in an installation space of the housing.

FIG. 11 is a view showing a battery system including cylindrical battery cells according to another embodiment of the present disclosure.

### DETAILED DESCRIPTION OF EMBODIMENTS

Hereinafter, embodiments are described in detail with reference to the accompanying drawings to be easily practiced by those skilled in the art to which the present disclosure pertains. However, the present disclosure may be implemented in various different forms and is not limited to the embodiments described herein. In addition, in the drawings, portions unrelated to the description are omitted to clearly describe the present disclosure, and similar portions are denoted by similar reference numerals throughout the specification.

In addition, throughout the specification, when one part is referred to as being “connected to” another part, one part and another part may be “directly connected to” each other, or may be “electrically connected to” each other with still another part interposed therebetween.

Throughout the specification, when one member is referred to as being positioned on “another member”, one member and another member may be in contact with each other, or a third member may be interposed between one member and another member.

Throughout the specification, including one component is to be understood to imply the inclusion of other components rather than the exclusion of other components, unless explicitly described to the contrary. As used throughout the specification, a term of degree “about”, “substantially”, or the like is used to indicate the number of a stated meaning or its approximation when its manufacturing or material tolerance inherent therein is given. Such a term is used to prevent unscrupulous infringers from unfairly using the present disclosure in which exact or absolute figures are stated to facilitate the understanding of this application. As used throughout the specification, a term of “step of (doing)” or “step of˜” does not indicate a “step for˜”.

Hereinafter, the embodiments of the present disclosure are described in detail with reference to the accompanying drawings and the description provided below. However, the present disclosure is not limited to the embodiments described herein, and may also be embodied in another form. Same reference numerals denote same components throughout the specification.

Hereinafter, the description describes a battery system including cylindrical battery cells according to an embodiment of the present disclosure.

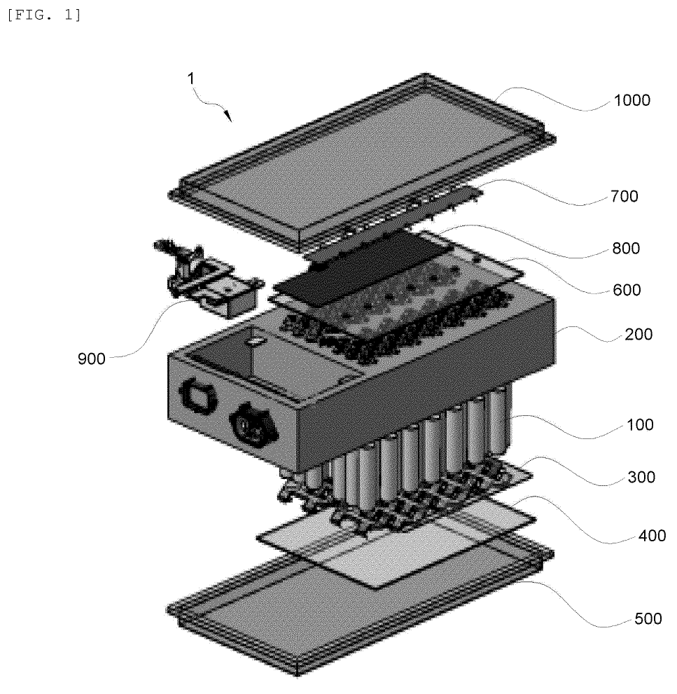

FIG. 1 is an exploded perspective view of the battery system including cylindrical battery cells according to an embodiment of the present disclosure.

Referring to FIG. 1, a battery system 1 including cylindrical battery cells may include a cylindrical battery cell 100, a housing 200, a bus bar receptor 300, a first thermally-conductive adhesive layer 400, a lower cover 500, a second thermally-conductive adhesive layer 600, a flexible printed circuit 700, a printed wiring circuit board 800, an electronic component 900, and an upper cover 1000.

First, the cylindrical battery cell 100 is described.

The cylindrical battery cell 100 may be a conventional cylindrical battery cell capable of charging and discharging, and the plurality of cylindrical battery cell may be provided and accommodated in the housing 200 described below.

Next, the housing 200 is described.

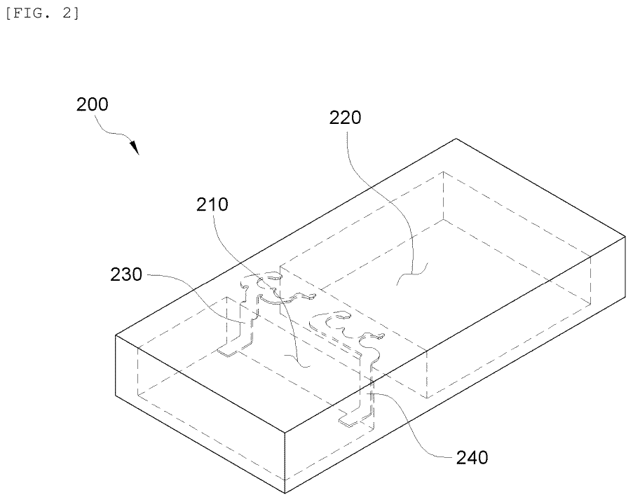

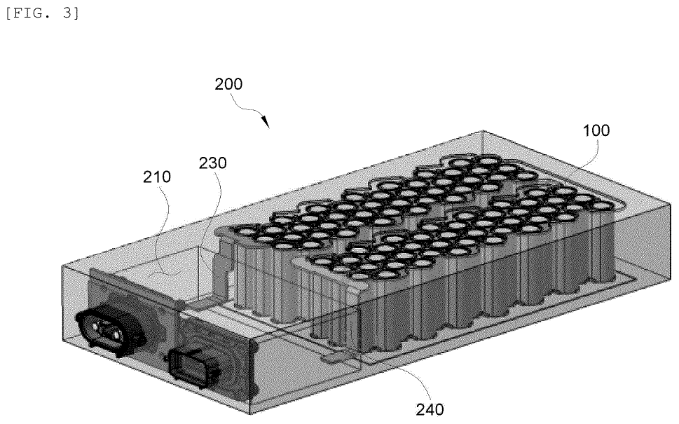

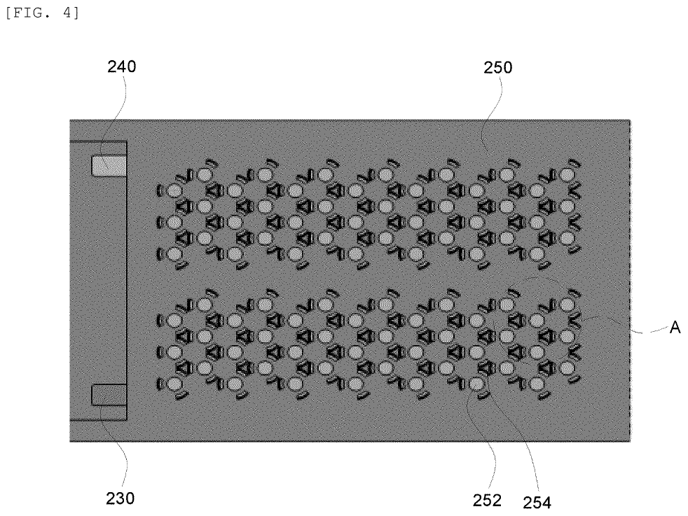

FIG. 2 is a perspective view of the housing whose lower part faces upward; FIG. 3 is a perspective view of the housing whose lower part faces upward and accommodating the plurality of cylindrical battery cells; and FIG. 4 is a view showing an upper part of the housing.

Referring to FIGS. 2 to 4, the housing 200 may include an installation space 210, an accommodation space 220, a positive bus bar 230, a negative bus bar 240, and a sealing part 250, and may be made of a thermally conductive plastic that may easily conduct heat.

The installation space 210 may be a space disposed in one side of the housing and having a predetermined volume, and the electronic component 900 described below may be installed in the installation space 210.

The accommodation space 220 may be disposed in one side of the housing to be adjacent to the installation space 210, and may be a space having a volume capable of accommodating the plurality of cylindrical battery cells 100 as shown in FIG. 3. Here, the plurality of cylindrical battery cells 100 may be accommodated in the accommodation space 220 for each negative electrode of the battery cells to face an upper part of the housing 200.

The positive bus bar 230 may be electrically connected to each positive electrode of the plurality of cylindrical battery cells 100, and have one side protruding into the installation space 210 as shown in FIG. 2. The positive bus bar 230 may be insert-injected into the housing 200, and have a plurality of positive bus bar holes 232.

The negative bus bar 240 may be electrically connected to each negative electrode of the plurality of cylindrical battery cells 100, and have one side protruding into the installation space 210 as shown in FIG. 2. The negative bus bar 240 may be insert-injected into the housing 200, and have a plurality of negative bus bar holes 242.

Meanwhile, the positive bus bar 230 and the negative bus bar 240 may be insert-injected into the housing 200. Accordingly, as shown in FIG. 2, one side of the positive bus bar 230 may protrude to a portion of the installation space 210 that is adjacent to the upper part of the housing 200, and one side of the negative bus bar 240 may also protrude to a portion of the installation space 210 that is adjacent to the upper part of the housing 200.

As such, one side of the positive bus bar 230 and one side of the negative bus bar 240 may protrude to a portion of the installation space 210 that is adjacent to the upper part of the housing 200. Accordingly, one side of the positive bus bar 230 and one side of the negative bus bar 240 may be easily connected to the electronic component 900 installed in the installation space 210.

As shown in FIG. 4, the sealing part 250 may seal the upper part of the housing 200 to thus seal the upper part of the accommodation space 220, and have a plurality of insertion grooves 252 and a plurality of fixing grooves 254.

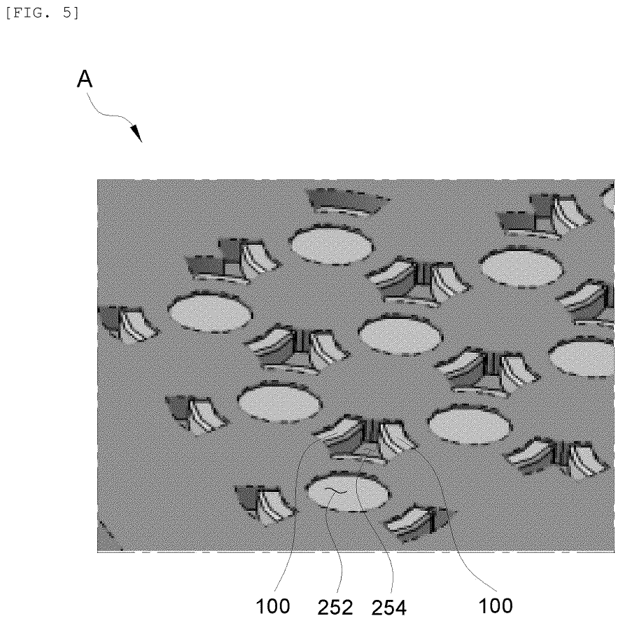

FIG. 5 is an enlarged view of a part A of FIG. 4.

Referring to FIG. 5, the plurality of insertion grooves 252 may be disposed in the sealing part 250 for an exterior of the housing 200 to communicate with the accommodation space 220, and one side of each of the cylindrical battery cells 100 in a length direction where the negative electrode is disposed may be inserted into the insertion grooves 252. In this way, as one side of each battery cell in the length direction may be inserted into the insertion groove 252, and each cylindrical battery cell 100 may thus be stably disposed in the accommodation space 220.

The plurality of fixing grooves 254 may be disposed in the sealing part 250 for the exterior of housing 200 to communicate with the accommodation space 220. As shown in FIG. 5, one side of each of the plurality of cylindrical battery cells 100 adjacent to each other in the length direction where the negative electrode is disposed, may be at least partially exposed to the fixing groove 254.

Next, the bus bar receptor 300 is described.

The bus bar receptor 300 may be an injection-molded product including the bus bar therein, and the injection-molded product may be made of a plastic material for insulation. For an example, the injection-molded product may be made of a thermally conductive plastic.

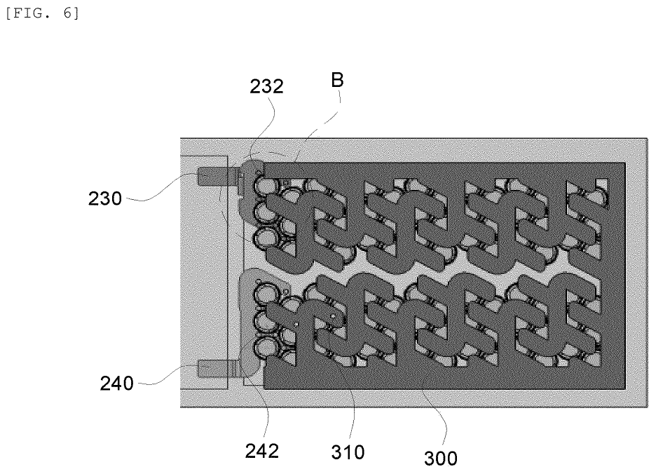

FIG. 6 is a view showing the bus bar receptor coupled to the lower part of the housing.

In addition, as shown in FIG. 6, the bus bar receptor 300 may be coupled to a lower part of the accommodation space 220 to support one side of each of the plurality of cylindrical battery cells 100 in the length direction where the positive or negative electrode is accommodated in the accommodation space 220 are disposed.

As such, as the bus bar receptor 300 supports one side of each of the plurality of cylindrical battery cells 100 in the length direction where the positive or negative electrode is accommodated in the accommodation space 220 is disposed, thus preventing the plurality of cylindrical battery cells 100 from being spaced apart from the lower part of the accommodation space 220.

Meanwhile, the bus bar included in the bus bar receptor 300 may electrically connect the positive electrodes of the plurality of cylindrical battery cells 100 with the positive bus bar 230, and electrically connect the negative electrodes of the plurality of cylindrical battery cells 100 with the negative bus bar 240.

For example, as shown in FIG. 6, the bus bar receptor 300 including the bus bar may have an aggregate shape of a plurality of ‘X’ shaped structures to thus connect the plurality of cylindrical battery cells 100 in series or parallel with each other, electrically connect the positive electrodes of the plurality of cylindrical battery cells 100 with one side of the positive bus bar 230 that protrudes into the installation space 210, and electrically connect the negative electrodes of the plurality of cylindrical battery cells 100 with one side of the negative bus bar 240 that protrudes into installation space 210.

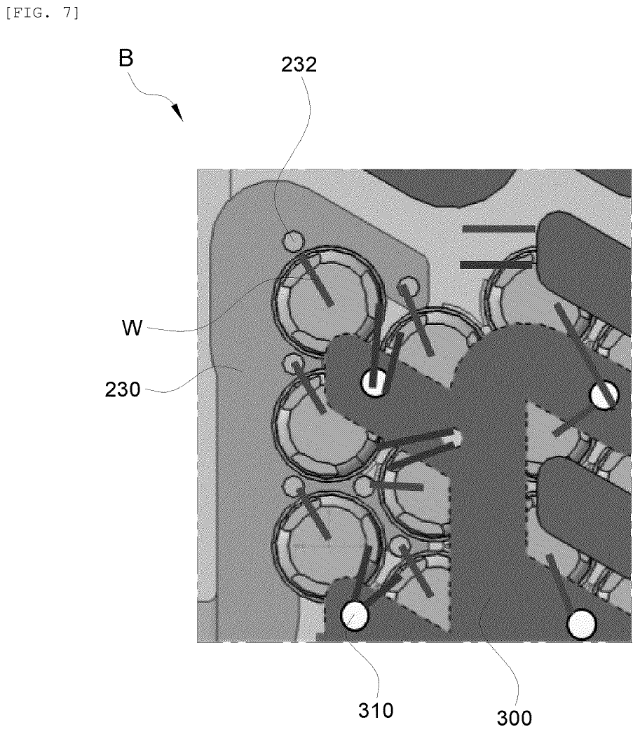

FIG. 7 is an enlarged view of a part B of FIG. 6.

Meanwhile, referring to FIG. 7, the bus bar receptor 300 may have a plurality of bus bar receptor holes 310 passing through the bus bar, and some of the plurality of positive bus bar holes 232 and the plurality of bus bar receptor holes 310 may be wire (w)-bonded with each other to electrically connect the positive bus bar 230 with the positive electrodes of the plurality of cylindrical battery cells 100.

In addition, although not shown in the drawings, some of the plurality of negative bus bar holes 242 and the plurality of bus bar receptor holes 310 may be wire (w)-bonded with each other to electrically connect the negative bus bar 240 with the negative electrodes of the plurality of cylindrical battery cells 100.

Next, the first thermally-conductive adhesive layer 400 is described.

The first thermally-conductive adhesive layer 400 may be formed by applying a thermally conductive adhesive to a lower part of the bus bar receptor 300. The thermally conductive adhesive may be an adhesive which may effectively conduct heat, and couple the plurality of cylindrical battery cells 100 with the bus bar receptor 300.

For example, the thermally conductive adhesive may be made by any one of urethane-based, silicone-based, and epoxy-based materials, which have the thermal conductivity, dielectric breakdown voltage, and adhesive strength of a predetermined level and satisfy a predetermined level of flame retardancy, or a mixture of two or more of these materials.

The plurality of cylindrical battery cells 100 may be fixed to the housing 200 and the bus bar receptor 300 by the first thermally-conductive adhesive layer 400.

Next, the lower cover 500 is described.

The lower cover 500 may be coupled to a lower part of the housing 200 to cover the lower part of the housing 200 including a lower part of the first thermally-conductive adhesive layer 400.

The lower cover 500 may be made of aluminum or the thermally conductive plastic, heat emitted from the plurality of cylindrical battery cells 100 may be transferred to the bus bar receptor 300 made of the thermally conductive plastic, heat transferred to the bus bar receptor 300 may be transferred to the first thermally-conductive adhesive layer 400 made of the thermally conductive adhesive, and heat transferred to the first thermally-conductive adhesive layer 400 may be transferred to the lower cover 500 and effectively dissipated to the outside.

Alternatively, heat emitted from the plurality of cylindrical battery cells 100 may be transferred to the first thermally-conductive adhesive layer 400 made of the thermally conductive adhesive, and heat transferred to the first thermally-conductive adhesive layer 400 may be transferred to the lower cover 500 and effectively dissipate to the outside.

Next, the second thermally-conductive adhesive layer 600 is described.

The second thermally-conductive adhesive layer 600 may be formed by applying the thermally conductive adhesive to an upper part of the sealing part 250 except for the insertion groove 252. As such, the second thermally-conductive adhesive layer 600 may be formed on the upper part of the sealing part 250 except for the insertion groove 252. In this case, the thermally conductive adhesive may not be applied to one side of the cylindrical battery cell 100 in the length direction where the negative electrode exposed to the insertion groove 252 is disposed. Therefore, it is possible to easily electrically connect the flexible printed circuit described below with one side of the cylindrical battery cell 100 in the length direction where the negative electrode is disposed.

In addition, the thermally conductive adhesive may be applied to the fixing groove 254, and the plurality of cylindrical battery cells 100 brought into contact with the thermally conductive adhesive applied to the fixing groove 254 may be more effectively fixed into the accommodation space 220 by the adhesive strength of the thermally conductive adhesive.

The thermally conductive adhesive included in the second thermally-conductive adhesive layer 600 may be an adhesive which may effectively conduct heat.

For example, the thermally conductive adhesive may be made by any one of urethane-based, silicone-based, and epoxy-based materials, which have the thermal conductivity, dielectric breakdown voltage, and adhesive strength of a predetermined level and satisfy a predetermined level of flame retardancy, or a mixture of two or more of these materials.

Meanwhile, heat emitted from the plurality of cylindrical battery cells 100 may be transferred to the second thermally-conductive adhesive layer 600 applied into the fixing groove 254 and in contact with the plurality of cylindrical battery cells 100, and heat transferred to the second thermally-conductive adhesive layer 600 may be transferred to the housing 200 in contact with the second thermally-conductive adhesive layer 600, and effectively emitted to the outside of the housing 200.

Next, the flexible printed circuit 700 is described.

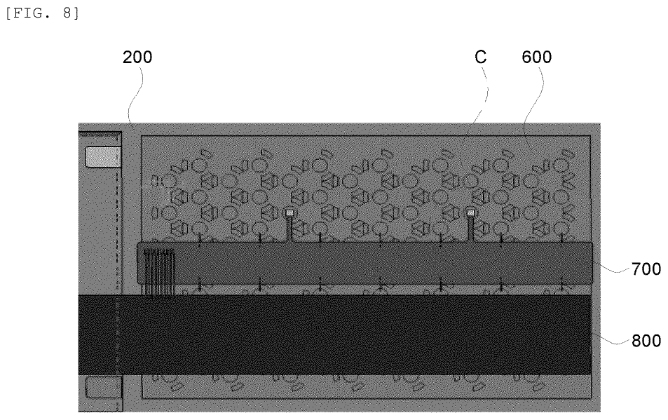

FIG. 8 is a view showing the flexible printed circuit board and the printed wiring circuit board coupled to the upper part of the housing.

Referring to FIG. 8, the flexible printed circuit 700 may be a conventional flexible printed circuit (FPCB) and coupled to the housing 200 to be disposed on an upper part of the second thermally-conductive adhesive layer 600.

For example, the flexible printed circuit 700 may be bonded or wire-bonded to the housing 200 by using the thermally conductive adhesive to be disposed on the upper part of the second thermally-conductive adhesive layer 600.

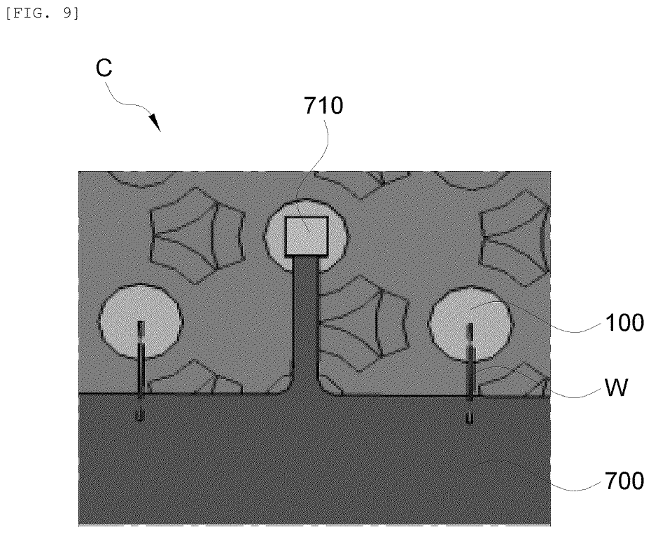

FIG. 9 is an enlarged view of a part C of FIG. 8.

Meanwhile, as shown in FIG. 9, the flexible printed circuit 700 may be electrically connected to one side of at least one cylindrical battery cell 100 in the length direction where the negative electrode exposed to the fixing groove 254 is disposed by wire (w)-bonding to measure a voltage of the cylindrical battery cell 100.

In addition, as shown in FIG. 9, a chip-shaped temperature sensor 710 may be attached to one side of at least one cylindrical battery cell 100 in the length direction where the negative electrode is disposed, and the flexible printed circuit 700 may be electrically connected to the temperature sensor 710 to measure a temperature of the cylindrical battery cell 100.

Next, the printed wiring circuit board 800 is described.

Referring to FIG. 8, the printed wiring circuit board 800 may be a conventional flexible printed circuit (PCB) and coupled to the housing 200 to be disposed on the upper part of the second thermally-conductive adhesive layer 600.

For example, the printed wiring circuit board 800 may be bonded or wire-bonded to the housing 200 by using the thermally conductive adhesive to be disposed on the upper part of the second thermally-conductive adhesive layer 600.

In addition, the printed wiring circuit board 800 may be electrically connected to the flexible printed circuit 700 by wire-bonding or the like.

Next, the electronic component 900 is described.

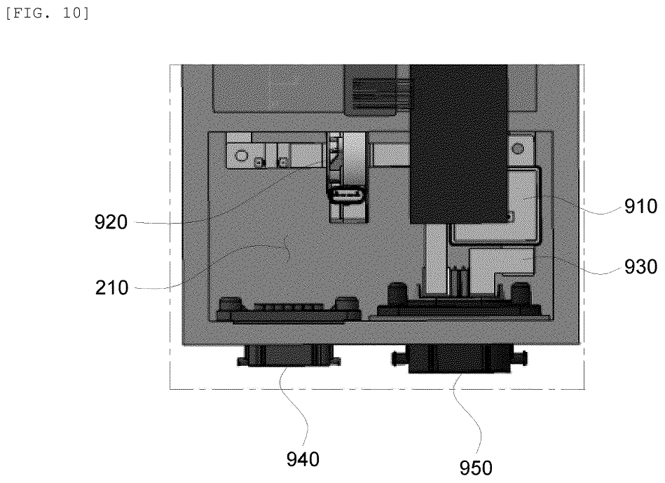

FIG. 10 is a view showing the electronic component installed in the installation space of the housing.

Referring to FIG. 10, the electronic component 900 may include an electronic relay 910, a hall sensor 920, a connection bus bar 930, a communication connector 940, and a high current connector 950.

The electronic relay 910 and the hall sensor 920 may have the same functions and configurations as the conventional electronic relay and hall sensor, and the connection bus bar 930 may serve to electrically connect the flexible printed circuit 700 or the printed wiring circuit board 800 with the electronic component 900.

In addition, the communication connector 940 and the high current connector 950 may be installed to communicate the installation space 210 with the outside of the housing 200, and electrically connect the printed wiring circuit board 800 with a vehicle component.

Next, the upper cover 1000 is described.

The upper cover 1000 may be coupled to the upper part of the housing 200 to cover the upper part of the second thermally-conductive adhesive layer 600, the flexible printed circuit 700, and the printed wiring circuit board 800.

The upper cover 1000 may be made of aluminum or the thermally conductive plastic, heat emitted from the plurality of cylindrical battery cells 100 may be transferred to the second thermally-conductive adhesive layer 600 made of the thermally conductive adhesive, and heat transferred to the second thermally-conductive adhesive layer 600 may be transferred to the upper cover 1000 and effectively dissipated to the outside.

Meanwhile, a battery system 2 including cylindrical battery cells according to another embodiment of the present disclosure may include a cylindrical battery cell 100, a housing 200, a bus bar receptor 300, a first thermally-conductive adhesive layer 400, a second thermally-conductive adhesive layer 600, a flexible printed circuit 700, a printed wiring circuit board 800, an electronic component 900, and further include a case 1100 and a case cover 1200.

The battery system 2 including cylindrical battery cells has the same configuration as the battery system 1 including cylindrical battery cells except for the housing 200, the case 1100 and the case cover 1200. Therefore, the housing 200, the case 1100, and the case cover 1200 are described below.

Next, the housing 200 is described.

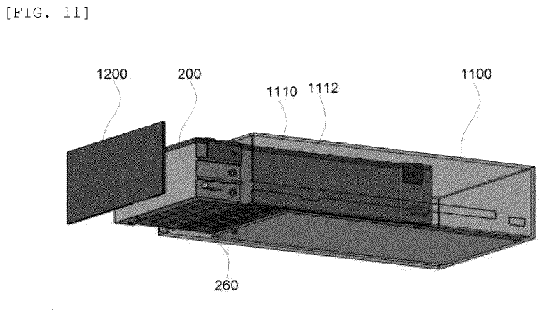

FIG. 11 is a view showing the battery system including cylindrical battery cells according to another embodiment of the present disclosure.

The housing 200 basically has the same structure as the housing 200 of the battery system 1 including cylindrical battery cells. However, as shown in FIG. 11, the housing 200 may include a guide protrusion 260 disposed on a side of the housing.

Next, the case 1100 is described.

Referring to FIG. 11, the case 1100 may have one open side into which the housing 200 is slide-inserted, and a guide groove 1110 in which the guide protrusion 260 disposed in the housing 200 is inserted and moved.

In addition, the guide groove 1110 may have a step 1112 at a predetermined position for the guide protrusion 260 to be seated thereon.

When the housing 200 is slide-inserted into the case 1100 for the guide protrusion 260 to be inserted into the guide groove 1110, the housing 200 may be moved into the case 1100 while the lower part coupled to the first thermally-conductive adhesive layer 400 is prevented from coming into contact with the case 1100.

The guide protrusion 260 may then be seated on the step 1112 when the housing 200 is moved to a predetermined position in the case 1100. Here, the lower part of the housing 200 that is coupled with the first thermally-conductive adhesive layer 400 may be brought into contact with the case 1100 and accommodated in the case 1100.

Next, the case cover 1200 is described.

Referring to FIG. 11, the case cover 1200 may have a shape of a plate which may seal the open side of the case 1100.

The case cover 1200 may seal one open side of the case 1100 accommodating the housing 200, and the case 1100 may thus stably accommodate the housing 200 and another component of the battery system 2 including cylindrical battery cells coupled to the housing 200.

As described above, in the battery system including the cylindrical battery cells according to the present disclosure, the positive and negative bus bars electrically connected to the plurality of cylindrical battery cells may all protrude into the installation space where the electronic component is installed. Therefore, it is unnecessary to have any separate bus bar to electrically connect the positive and negative bus bars and the electronic component, which may reduce the manufacturing cost of the battery system.

In addition, the battery system according to the present disclosure may include the thermally-conductive adhesive layer effectively transferring heat emitted from the plurality of cylindrical battery cells to the lower cover and the housing, thus effectively dissipating heat emitted from the plurality of cylindrical battery cells.

In addition, the battery system according to the present disclosure may effectively dissipate heat emitted from the plurality of cylindrical battery cells accommodated in the battery system without any separate heat dissipation device, thus reducing its manufacturing cost.

As set forth above, in the battery system including the cylindrical battery cells according to the present disclosure, the positive and negative bus bars electrically connected to the plurality of cylindrical battery cells may all protrude into the installation space where the electronic component is installed. Therefore, it is unnecessary to have any separate bus bar to electrically connect the positive and negative bus bars and the electronic component, which may reduce the manufacturing cost of the battery system.

In addition, the battery system according to the present disclosure may include the thermally-conductive adhesive layer effectively transferring heat emitted from the plurality of cylindrical battery cells to the lower cover and the housing, thus effectively dissipating heat emitted from the plurality of cylindrical battery cells.

In addition, the battery system according to the present disclosure may effectively dissipate heat emitted from the plurality of cylindrical battery cells accommodated in the battery system without any separate heat dissipation device, thus reducing its manufacturing cost.

The above-described embodiments are illustratively provided, and it is apparent to those skilled in the art to which the present disclosure pertains that the present disclosure may be embodied in another specific form without any change in the spirit or essential characteristics of the present disclosure. Therefore, it is to be understood that the embodiments described above are illustrative rather than restrictive in all aspects. For example, the components each described as a single type may also be implemented in a distributed manner, and similarly, the components described as being distributed from each other may also be implemented in a combined manner.

It is to be understood that the scope of the present disclosure is defined by the claims disclosed below rather than the detailed description provided above, and includes all alternations and modifications derived from the claims and their equivalents.

What is claimed is:

1. A battery system comprising:
a plurality of cylindrical battery cells, each battery cell including a positive electrode and a negative electrode;
a housing including;
an installation space where an electronic component is installed;
an accommodation space having a lower part open to accommodate the plurality of cylindrical battery cells;
a positive bus bar installed in the accommodation space and having one side protruding into the installation space;
a negative bus bar installed in the accommodation space and having one side protruding into the installation space; and
a sealing part configured to seal an upper part of the accommodation space, and having a plurality of insertion grooves into which a side where the negative electrode is disposed of each of the cylindrical battery cells in a length direction is inserted;
a bus bar receptor including either the positive bus bar or the negative bus bar therein, and coupled to the lower part of the accommodation space to support one side of each of the cylindrical battery cells in the length direction where the positive electrode or the negative electrode is disposed, the bus bar receptor configured to electrically connect the positive electrodes of the plurality of cylindrical battery cells with the positive bus bar, and configured to electrically connect the negative electrodes of the plurality of cylindrical battery cells with the negative bus bar;
a first thermally-conductive adhesive layer formed by applying a thermally conductive adhesive to a lower part of the bus bar receptor;
a lower cover coupled to a lower part of the housing to cover the lower part of the housing including a lower part of the first thermally-conductive adhesive layer;
a second thermally-conductive adhesive layer formed by applying the thermally conductive adhesive to an upper part of the sealing part except for the insertion groove;
a flexible printed circuit coupled to the housing to be disposed on an upper part of the second thermally-conductive adhesive layer;
a printed wiring circuit board coupled to the housing to be disposed on the upper part of the second thermally-conductive adhesive layer;
at least one electronic component installed in the installation space; and
an upper cover coupled to an upper part of the housing to cover the upper part of the housing including the installation space, the flexible printed circuit, and the printed wiring circuit board.

2. The battery system of claim 1, wherein the sealing part has a plurality of fixing grooves to which one side of each of the plurality of cylindrical battery cells adjacent to each other in the length direction where the negative electrode is disposed is at least partially exposed, and
wherein the second thermally-conductive adhesive layer is formed by applying the thermally conductive adhesive to the fixing groove.

3. The battery system of claim 2, wherein the positive bus bar has a plurality of positive bus bar holes,
wherein the negative bus bar has a plurality of negative bus bar holes,
wherein the bus bar receptor has a plurality of bus bar receptor holes passing through the bus bar,
wherein some of the plurality of positive bus bar holes and the plurality of bus bar receptor holes are wire-bonded to each other to electrically connect the positive bus bar with the positive electrodes of the plurality of cylindrical battery cells, and
wherein some of the plurality of negative bus bar holes and the plurality of bus bar receptor holes are wire-bonded to each other to electrically connect the negative bus bar with the negative electrodes of the plurality of cylindrical battery cells.

4. The battery system of claim 3, wherein the flexible printed circuit is electrically connected to one side of at least one of the cylindrical battery cells in the length direction where the negative electrode exposed to the fixing groove is disposed to measure a voltage of the cylindrical battery cell, and
wherein the flexible printed circuit and the printed wiring circuit board are electrically connected with each other.

5. The battery system of claim 4, wherein the flexible printed circuit and one side of the cylindrical battery cell in the length direction where the negative electrode is disposed are electrically connected with each other by wire-bonding, and
wherein the flexible printed circuit and the printed wiring circuit board are electrically connected with each other by wire-bonding.

6. The battery system of claim 5, wherein a chip-shaped temperature sensor is attached to one side of at least one cylindrical battery cell in the length direction where the negative electrode is disposed, and
wherein the flexible printed circuit is electrically connected to the temperature sensor to measure a temperature of the cylindrical battery cell.

7. The battery system of claim 6, wherein the flexible printed circuit is bonded or wire-bonded to the housing by using the thermally conductive adhesive, and
wherein the printed wiring circuit board is bonded or wire-bonded to the housing by using the thermally conductive adhesive.

8. The battery system of claim 7, wherein the electronic component includes an electronic relay, a hall sensor, and a connection bus bar.

9. The battery system of claim 8, wherein the electronic component includes a communication connector and a high current connector installed to communicate the installation space with an outside of the housing, and configured to electrically connect the printed wiring circuit board with a vehicle component.

10. The battery system of claim 9, wherein the housing is made of thermally conductive plastic.

11. A battery system comprising:
a plurality of cylindrical battery cells, each battery cell including a positive electrode and a negative electrode;
a housing including;
an installation space where an electronic component is installed;
an accommodation space having a lower part open to accommodate the plurality of cylindrical battery cells;
a positive bus bar installed in the accommodation space and having one side protruding into the installation space;
a negative bus bar installed in the accommodation space and having one side protruding into the installation space;
a sealing part configured to seal an upper part of the accommodation space, and having a plurality of insertion grooves into which a side where the negative electrode is disposed of each of the cylindrical battery cells in a length direction inserted; and
a guide protrusion disposed on a side of the housing;
a bus bar receptor including either the negative bus bar or the positive bus bar therein, and coupled to the lower part of the accommodation space to support one side of each of the cylindrical battery cells in the length direction where the positive electrode or the negative electrode is disposed, the bus bar receptor configured to electrically connect the positive electrodes of the plurality of cylindrical battery cells with the positive bus bar, and configured to electrically connect the negative electrodes of the plurality of cylindrical battery cells with the negative bus bar;
a first thermally-conductive adhesive layer formed by applying a thermally conductive adhesive to a lower part of the bus bar receptor;
a second thermally-conductive adhesive layer formed by applying the thermally conductive adhesive to an upper part of the sealing part except for the insertion groove;
a flexible printed circuit coupled to the housing to be disposed on an upper part of the second thermally-conductive adhesive layer;
a printed wiring circuit board coupled to the housing to be disposed on the upper part of the second thermally-conductive adhesive layer;
at least one electronic component installed in the installation space;
an upper cover coupled to an upper part of the housing to cover the upper part of the housing including the installation space, the flexible printed circuit, and the printed wiring circuit board;
a case having one open side into which the housing is slide-inserted and a guide groove in which the guide protrusion is inserted and moved; and
a case cover capable of sealing the open side of the case.

12. The battery system of claim 11, wherein the guide groove has a step at a predetermined position for the guide protrusion to be seated thereon.
